(19) United States
(12) Patent Application Publication
(10) Pub. No.: US 2010/0042406 A1
(43) Pub. Date: Feb. 18, 2010

(54) Audio signal processing using improved perceptual model

(76) Inventors: James David Johnston, Morristown, NJ (US); Shyh-Shiaw Kuo, Basking Ridge, NJ (US)

Correspondence Address: AT & T- Legal Department - Brendzel, ATTN: Patent Docketing, Rm 2A-207, Bedminster, NJ, 07921, US

(21) Appl. No.: 10/090,544

(22) Filed: Mar. 4, 2002

(51) Int. Cl. G10L 19/02

(52) U.S. Cl. 704/200.1; 704/E19.001

(57) ABSTRACT

A perceptual model based on psychoacoustic auditory experiments is based on the (time domain) roughness of an input signal envelope in particular cochlea filter bands rather than the noise-like vs. tonal nature of the input signal. In illustrative embodiments, frequency domain techniques are used to develop envelope and envelope roughness measures, and such roughness measures are then used to derive Noise Masking Ratio (NMR) values for achieving a high level of noise masking in coder embodiments. Coder embodiments based on present inventive teachings are compatible with well-known AAC coding standards.

### FIELD OF THE INVENTION

The present invention relates to audio signal processing systems and methods, including such systems and methods for spatial shaping of noise content of such audio signals. More particularly, the present invention relates to methods and systems for shaping noise associated with audio signals to permit hiding such noise in bands of lower sensitivity for human auditory perception. Still more particularly, the present invention relates to noise shaping to improve audio coding, including reduced bit-rate coding.

### BACKGROUND OF THE INVENTION

It has long been known that the human auditory response can be masked by audio-frequency noise or by other-than-desired audio frequency sound signals. See, B. Scharf, “Critical Bands,” Chap. 5 in J. V. Tobias, Foundations of Modern Auditory Theory, Academic Press, New York, 1970. While critical bands, as noted by Scharf, relate to many analytical and empirical phenomena and techniques, a central features of critical band analysis relates to the characteristic of certain human auditory responses to be relatively constant over a range of frequencies. In the cited Tobias reference, at page 162, one possible table of 24 critical bands is presented, each having an identified upper and lower cutoff frequency corresponding to certain behavior of human cochlea. In some contexts, these or related bands are described in terms of a Bark scale. The totality of the bands covers the audio frequency spectrum up to 15.5 kHz. Critical band effects have been used to advantage in designing coders for audio signals. See, for example, M. R. Schroeder et al, “Optimizing Digital Speech Coders By Exploiting Masking Properties of the Human Ear,” Journal of the Acoustical Society of America, Vol. 66, pp. 1647-1652, December, 1979 and U.S. Pat. Re 36,714 issued May 23, 2000 to J. D. Johnston and K. Brandenburg.

In particular, noise shaping techniques have been widely employed in many speech, audio and image applications such as coding (compression) to take advantage of noise masking techniques in critical bands. See generally, N. Jayant, J. Johnston, and R. Safranek, “Signal compression based on models of human perception,” Proceedings of the IEEE, vol. 81, October 1993. Other areas in which noise shaping has proven useful include data hiding and watermarking, as described, for example, in G. C. Langelaar, I. Setyawan, and R. L. Lagendijk, “Watermarking digital image and video data,” IEEE Signal Processing Magazine, 2000.

One purpose of such prior techniques is to shape noise to be less perceptible (or not perceptible at all) in the final processed host signal. Many of these techniques shape noise by altering its spectrum, as, for example, using perceptual weighting filters in Code-Excited Linear Predictive (CELP) speech coders, and employing psychoacoustic models in audio coders. Some prior techniques developed for specific classes of applications have not proven useful over a wider range of applications.

Another approach known as temporal noise shaping (TNS) was described by J. Herre and J. D. Johnston in “Enhancing the performance of perceptual audio coding by using temporal noise shaping (TNS),” 101st AES Convention, Los Angeles, November 1996. The TNS method shapes the temporal structure of the quantization noise, instead of its spectrum as in many prior methods. One result of using the TNS approach is to effectively reduce the so-called pre-echo problem well known in audio coding that arises from the spread of quantization noise in the time domain within a transform window. In another aspect, TNS has proven useful in processing of certain signals having dominant pitch components. Importantly, TNS has greatly contributed to the high performance of MPEG Advanced Audio Coder (AAC). See, for example, J. D. Johnston, S. R. Quackenbush, G. A. Davidson, K. Brandenburg, and J. Herre, “MPEG audio coding,” in Wavelet, subband and block transforms in communications and multimedia (A. N. Akansu and M. J. Medley, eds.), ch. 7, pp. 207-253, Kluwer Academic Publishers, 1999.

As noted above, prior noise shaping techniques have operated on signals in frequency bands corresponding roughly to respective frequency bands occurring in the human cochlea (i.e., cochlea filter bands). Particular processing operations are typically based, at least in part, on an assumed model for human hearing. While many such models have proven useful in providing a basis for noise shaping purposes, nevertheless shortcomings have been discerned when applying various prior models.

Thus, for example, prior modeling of hearing has in some cases been based, at least in part, on processing based on the tonal and noise-like characteristics of input signals to determine a noise threshold, i.e., a signal level below which noise will be masked. See, for example, U.S. Pat. No. 5,341,457 issued Aug. 24, 1994 to J. L. Hall II and J. D. Johnston. Often, it proves advantageous to characterize this noise-to-signal ration as a Noise Masking Ratio (NMR). However, as noted, e.g., in U.S. Pat. No. 5,699,479 issued Dec. 16, 1997 to J. B. Allen, et al., speech and music coders that exploit masking properties of an input sound to hide quantization noise are hampered by the difference in masking efficacy of tones and noise like signals when computing the masked threshold. In particular, developers of these coders seek to define the two classes of signals, as well as to identify the two classes in sub-bands of the input signal.

### SUMMARY OF THE INVENTION

Limitations of the prior art are overcome and a technical advance is made in accordance with the present invention described in illustrative embodiments herein.

In accordance with one illustrative embodiment based on psychoacoustic experiments, a perceptual model is introduced that is not based on evaluating the noise-like vs. tonal nature of the input signal. Rather, the masking ability of a signal in accordance with this illustrative embodiment is based on the (time domain) roughness of the envelope of an input signal in particular cochlea filter bands. In illustrative implementations, frequency domain techniques are used to develop necessary envelope and envelope roughness measures. A relationship is then advantageously developed between envelope roughness and NMR.

Thus, illustrative embodiments of the present invention provide systems and methods for realizing results of time domain masking techniques in the frequency domain, i.e., for calculating NMRs for use in the frequency domain using time domain masking theory and improved processing techniques.

Illustrative coder embodiments of the present invention prove to be compatible with well-known AAC coding standards. Using present inventive techniques, standard MDCT coefficients can be efficiently quantized based on the present improved human perceptual model and improved processing techniques.

### BRIEF DESCRIPTION OF THE DRAWING

The above-summarized description of illustrative embodiments of the present invention will be more fully understood upon a consideration of the following detailed description and the attached drawing, wherein:

FIG. 1 is Bark scale plot of roughness of illustrative noise and pure tone input signals as determined in accordance with an aspect of the present invention.

FIG. 2 is a Bark scale plot of Noise Masking Ratio (NMR) for the illustrative noise and pure tone input signals reflected in FIG. 1, where such NMR plots are determined in accordance with another aspect of the present invention.

FIG. 3 is system diagram including a perceptual coder and decoder employing an embodiment of the present invention.

### DETAILED DESCRIPTION

Present inventive processing of input signals advantageously comprises three main functions: (i) determining the envelope of the part of the audio signal x(t) which is inside a particular cochlea filter band (or so called critical band), (ii) quantifying a roughness measure for the envelope, and (iii) mapping the roughness measure to a NMR for the part of the input signal. This process can then be repeated for determining NMRs of the signal for each critical band. The analysis and methodology for each of these processing functions will now be explored in turn.

### Signal Envelope for a Particular Cochlea Filter Band

It has been shown, e.g., in J. Herre and J. D. Johnston, “Enhancing the performance of perceptual audio coding by using temporal noise shaping (TNS),” in 101^{st} AES Convention, Los Angeles, November 1996, that given a real, time domain signal, x(t), the square of its Hilbert envelope, e(t), can be expressed as

e(t)=F⁻¹{∫\tilde{X}(ε)·\tilde{X}*(ε−f)dε} (1)

If X(f) is the Fourier transform of x(t), then \tilde{X}(f) is the Fourier transform of its analytic signal, and is a single sided frequency spectrum defined as

$$\tilde{X} ( f ) = \{ \begin{matrix}0 & f < 0 \\ X ( f ) & f = 0 \\ 2 X ( f ) & f > 0\end{matrix} \qquad ( 2 )$$

The signal envelope, which corresponds to the part of the signal that is inside a specific cochlea filter band, can be calculated by first filtering \tilde{X}(f) of (1) by the cochlea filter, Hᵢ (f), i.e.,

\tilde{X}ᵢ(f)=\tilde{X}(f)Hₗ(f) (3)

Cochlea bands and filtering are described, e.g., in J. B. Allen, “Cochlear micromechanics: A physical model of transduction,” JASA, vol. 68, no. 6, pp. 1660-1670, 1980; and in J. B. Allen, “Modeling the noise damaged cochlea,” in The Mechanics and Biophysics of Hearing (P. Dallos, C. D. Geisler, J. W. Matthews, M. A. Ruggero, and C. R. Steele, eds.), (New York), pp. 324-332, Springer-Verlag, 1991.

Thus, Eq. (1) can be re-written as:

eₗ(t)=F⁻¹{∫\tilde{X}ᵢ(ε)·\tilde{X}ₗ*(ε−f)dε} (4)

In Eq. (4) eᵢ(t) is the square of the signal envelope corresponding to the ith cochlea filter band whose characteristic frequency is fᵢ. F⁻¹ in Eq. 4 represents the well-known Inverse Fourier Transform.

### Quantifying Envelope Roughness

Eq. (1), or Eq. (4), shows that an input audio signal envelope may be derived from the autocorrelation function of its single sided frequency spectrum, \tilde{X}(f). This relationship will be seen to be the dual of the following well-known formula which relates the power spectrum density of a signal, Sₓₓ(f), to is autocorrelation function in time domain:

Sₓₓ(f)=F{∫x(τ)·x*(τ−t)dτ} (5)

where F denotes Fourier Transform.

By exploiting this duality, many well-established theories in time domain Linear Prediction (LP) processing can be applied to frequency domain. In particular, one well-known relationship between prediction gain and spectral flatness measure, described, for example, in N. S. Jayant and P. Noll, Digital Coding of Waveforms—Principles and Applications to Speech and Video, page 56. Prentice Hall, 1984, may be used to advantage. In accordance with such teachings, the rougher the frequency-domain spectrum Sₓₓ(f), the more predictable is the corresponding time signal x(t); i.e., the higher the prediction gain. (As is well known, prediction gain is defined as the ratio of original signal power to the power of the prediction residual error.)

Based on the duality of Eqs. (1) and (5), the following conclusion can be made: If linear prediction is applied to coefficients of \tilde{X}(f), the single sided spectrum of the time signal x(t), then a higher prediction gain corresponds to a rougher signal envelope e(t). Therefore, for Eq. (4), prediction of \tilde{X}ᵢ(f) in the frequency domain serves as a reliable measure of the roughness of the signal envelope, eᵢ(t). For an input signal comprising only white noise, prediction gain of its \tilde{X}ᵢ(f) will be the highest among all the signals, since it has the roughest envelope in time domain. On the other hand, prediction gain of \tilde{X}ₗ(f) for pure tones will be the smallest, since they have flat a time domain envelope.

Linear Prediction (LP) operations are well-known and are described, for example in the above-cited book by Jayant and Noll at page 267. In the context of the present description, the input to LP operations is advantageously chosen as \tilde{X}(f), rather than time-domain inputs, as is often the case.

Roughness of illustrative white noise and pure tone are shown in FIG. 1 on the traditional Bark scale. It should be noted that since the time signal is illustratively windowed by the well-known sin function (thereby increasing the roughness of the flat envelope of a pure tone), roughness of the illustrative pure tone is therefore greater than unity.

Calculate NMR from Roughness

In accordance with an illustrative embodiment of the present invention, mapping a calculated roughness measure for an arbitrary signal to the NMR of the signal is advantageously accomplished using the following steps:

1. The calculated roughness measure of an arbitrary signal is normalized by that of a pure tone, since a pure tone has the flatest envelope.

2. Square the normalized roughness, since NMR is required in the signal energy domain.

3. The value obtained in step 2 is raised to the 4^{th} power to take into account the effect of the cochlea compression.

The resulting value is then directly proportional to the NMR of the signal. In other words, the signal NMR is calculated as follows:

$${NMR}_{i} = c \cdot {[ \frac{{r}_{s} ( i )}{{r}_{t} ( i )} ]}^{8} , \qquad ( 6 )$$

where rₛ and rₜ are the roughness of an arbitrary signal and a pure tone, respectively. Subscript, i denotes values for the ith cochlea filter band. In accordance with another aspect of the illustrative embodiment, the constant, c, is calculated by averaging its values for all i obtained by substituting rₙ(i) (the calculated roughness for a white noise input signal) for rₛ(i) and the theoretical NMR values.

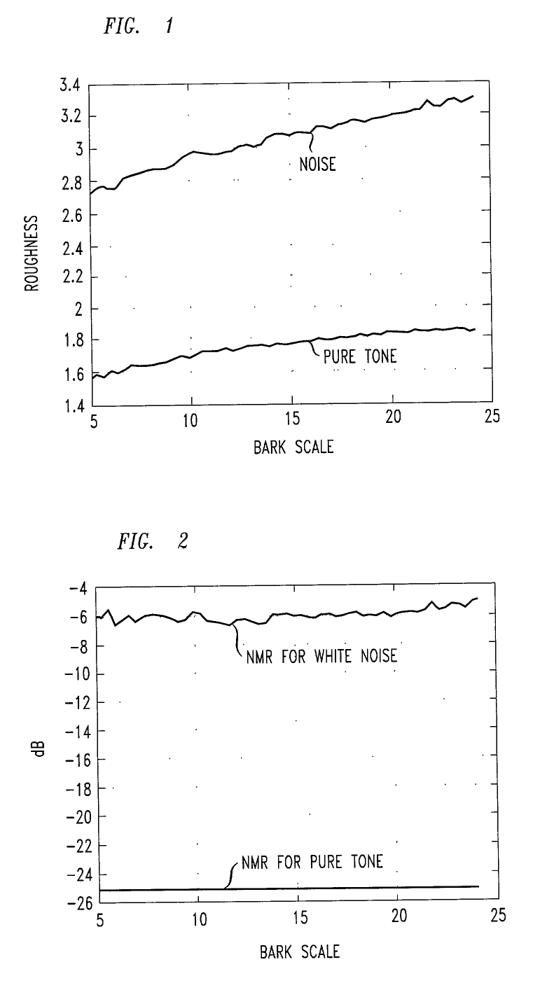

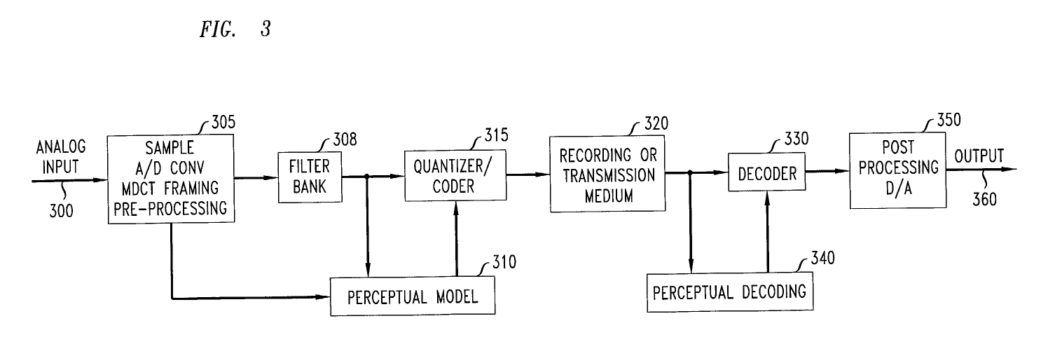

The plot of NMRs for white noise shown in FIG. 2 support the accuracy of Eq. (6). That is, it is clear that the resulting NMRs are very close to their theoretical value of −6 dB, as discussed, e.g., in R. P. Hellman, “Asymmetry in masking between noise and tone,” Perception and Psychophyics., vol. 11, pp. 241-246, 1972.

### Illustrative System Overview

FIG. 3 shows a system organization for an illustrative embodiment of the present invention. In FIG. 3, an analog signal on input 300 is applied to preprocessor 305 where it is sampled (typically at 44.1 kHz) and each sample is converted to a digital sequence (typically 16 bits) in standard fashion. Of course, if input audio signals are presented in digital form, no such sampling and conversion is required.

Preprocessor 305 then advantageously groups these digital values in frames (or blocks or sets) of, e.g., 2048 digital values, corresponding to, an illustrative 46 msec of audio input. Other typical values for these and other system or process parameters are discussed in the literature and known in well-known audio processing applications. Also, as is well known in practice, it proves advantageous to overlap contiguous frames, typically to the extent of 50 percent. That is, though each frame contains 2048 ordered digital values, 1024 of these values are repeated from the preceding 2048-value frame. Thus each input digital value appears in two successive frames, first as part of the second half of the frame and then as part of the first half of the frame. Other particular overlapping parameters are well-known in the art. These time-domain signal frames are then transformed in filterbank block 310 using. e.g., a modified discrete cosine transform (MDCT) such as that described in J. Princen, et al., “Sub-band Transform Coding Using Filter Bank Designs Based on Time Domain Aliasing Cancellation,” IEEE ICASSP, 1987, pp. 2161-2164. The illustrative resulting set of 1024 real coefficients (zero-frequency, Nyquist frequency, and all intermediate frequencies) resulting from the illustrative MDCT represents the short-term frequency spectrum of the input signal.

These MDCT coefficients are then quantized based on the NMRs calculated, illustratively using the method described above. Thus, by way of illustration:
1. For each frame (2048 samples resulted from block 305), calculate the Fourier Transform of its analytic signal, \tilde{X}(f) defined in Eq. 2.
2. For the ith scale factor band (SFB), calculate \tilde{X}ₗ(f) using Eq. 3, where the cochlear filter's (Hₗ(f)) characteristic frequency fᵢ is the center frequency of this particular scale factor band.
3. Perform Linear Prediction on \tilde{X}ᵢ(f) and denote its prediction gain as rₛ(i).
4. Use Eq. 6 to map the roughness of the signal in this SFB, rₛ(i), to NMRᵢ
5. Calculate the average signal power per frequency bin in this SFB, and then multiply it with NMRᵢ to get the scale factor for this SFB.
6. Quantize all MDCT coefficients in this SFB using the resulting scale factor.
7. Repeat step 2-6 for all SFBs.

Steps 1-5 illustratively correspond to the perceptual model block 310. Outputs of this block are scale factors for performing quantization in block 315 (step 6 above). All these scale factors will be sent as side information along with the quantized MDCT coefficients to medium 320.

Perceptual model block 310 shown in FIG. 3 includes the perceptual modeling improvements of the present invention described above in illustrative embodiments. Filter bank 308 is shown supplying frequency components for the respective SFB, i, to the quantizer/coder 315 and to perceptual model 310 for calculating the average signal power in the SFB (step 5). The NMR has to be calculated (step 1-5) from the corresponding time signal frame resulted from block 305.

Quantizer/coder block 315 in FIG. 3 represents well-known quantizer-coder structures that respond to perceptual model inputs and frequency components received from a source of frequency domain information, such as filter bank 308, for an input signal. Quantizer/coder 315 will correspond in various embodiments of the present invention to the well-known AAC coder, but other applications of the present invention may employ various transform or OCF coders and other standards-based coders.

Block 320 in FIG. 3 represents a recording or transmission medium to which the coded outputs of quantizer/coder 315 are applied. Suitable formatting and modulation of the output signals from quantizer/coder 315 should be understood to be included in the medium block 320. Such techniques are well known to the art and will be dictated by the particular medium, transmission or recording rates and other system parameters. Further, if the medium 320 includes noise or other corrupting influences, it may be necessary to include additional error-control devices or processes, as is well known in the art. Thus, for example, if the medium is an optical recording medium similar to the standard CD devices, then redundancy coding of the type common in that medium can be used with the present invention. If the medium is one used for transmission, e.g., a broadcast, telephone, or satellite medium, then other appropriate error control mechanisms will advantageously be applied. Any modulation, redundancy or other coding to accommodate (or combat the effects of) the medium will, of course, be reversed (or otherwise subject to any appropriate complementary processing) upon the delivery from the channel or other medium 320 to a decoder, such as 330 in FIG. 3.

Coding parameters, including scale factors information used at quantizer/coder 315 are therefore sent as side information along with quantized frequency coefficients. Such side information is used in decoder 330 and perceptual decoder 340 to reconstruct the original input signal from input 300 and supply this reconstructed signal on output port 360 after performing suitable conversion to time-domain signals, digital-to-analog conversion and any other desired post-processing in unit 350 in FIG. 3. NMR side information is, of course supplied to perceptual decoder 340 for use there in controlling decoder 330 in restoring uniform quantization of transform (frequency) domain signals suitable for transformation back to the time domain.

The originally coded information provided by quantizer/coder 315 will therefore be applied at a reproduction device, e.g., a CD player. Output on 360 is in such form as to be perceived by a listener upon playback as substantially identical to that supplied on input 100.

Those skilled in the art will recognize that numerous alternative embodiments of the present invention, and methods of practicing the present invention, in light of the present description.

What is claimed is:

1. A perceptual model for determining Noise Masking Ratios, NMRs, for audio signals x(t) in each cochlea filter band, the method comprising
determining a representation of the envelope of the part of said x(t) that is inside a particular cochlea filter band,
quantifying a roughness measure for said envelope,
mapping said roughness measure to a NMR for the part of the signal that is inside said particular cochlear filter band.

2. The method of claim 1 wherein said determining a representation of the envelope comprises determining e(t), the square of said envelope.

3. The method of claim 1 wherein said determining a representation of said envelope comprises determining \tilde{X}(f), where X(f) is the Fourier transform of x(t), and \tilde{X}(f) is the Fourier transform of the analytic signal corresponding to x(t), \tilde{X}(f) being a single sided frequency spectrum defined as
$$\tilde{X} ( f ) = \{ \begin{matrix}0 & f < 0 \\ X ( f ) & f = 0 \\ 2 X ( f ) & f > 0\end{matrix}$$
for f extending over a frequency range associated with a human cochlea.

4. The method of claim 3 further comprising
filtering said \tilde{X}(f) by a cochlear filter, Hᵢ(f), for i=1, 2, . . . N to form representations of said single-sided frequency spectrum for N discrete bands of said frequency range, said representations given by
\tilde{X}ᵢ(f)=\tilde{X}(f)Hₗ(f).

5. The method of claim 4 wherein said determining said envelope further comprises determining eᵢ(t) for said N discrete bands in accordance with
eᵢ(t)=F⁻¹{∫\tilde{X}ᵢ(ε)·\tilde{X}ₗ*(ε−f)dε}
where eᵢ(t) is the square of said signal envelope corresponding to the ith cochlea filter band having a characteristic frequency fᵢ.

6. The method of claim 5 wherein said quantifying a roughness measure for said envelope comprises performing a linear prediction of said envelope, eᵢ(t) for each i to determine corresponding banded roughness measures rₛ(i).

7. The method of claim 6 wherein said mapping said roughness measure to a NMR comprises normalizing said rₛ(i), for each i, with respect to a roughness measure for a pure tone, rₜ(i), for each i, to form a normalized roughness measure for each i.

8. The method of claim 7 wherein said mapping said roughness measure to a NMR further comprises squaring said normalized roughness measure for each i to form a squared roughness measure for each i.

9. The method of claim 8 wherein each said squared roughness measure is raised to the 4^{th} power to reflect cochlea compression.

10. The method of claim 6 wherein said mapping said roughness measure for each cochlear band i to a NMR comprises determining
$${NMR}_{i} = c \cdot {[ \frac{{r}_{s} ( i )}{{r}_{t} ( i )} ]}^{8} ,$$
where rₜ(i) is the roughness measure for a pure tone for each i, and c is a constant.

11. The method of claim 10 wherein said constant, c, is determined by performing a linear prediction of the envelope, eᵢ(t) for each i for a white noise input signal, thereby determining corresponding banded roughness measures rₙ(i)
substituting said rₙ(i) values for rₛ(i) in
$${NMR}_{i} = c \cdot {[ \frac{{r}_{s} ( i )}{{r}_{t} ( i )} ]}^{8} ,$$
substituting known theoretical values for NMRᵢ for white noise in the immediately preceding equation, thereby determining a value, cᵢ, for each i, and
averaging said values of cᵢ for all i to determine said value for c.

12. A method for coding audio signals x(t) in the frequency domain, the method comprising
for each band of a cochlear filter having a plurality of bands
determining a representation of the envelope of the part of said x(t) that is inside a particular cochlea filter band,
quantifying a roughness measure for said envelope,
mapping said roughness measure to a Noise Masking Ratio, NMR, for the part of x(t) that is inside said particular cochlear filter band,
quantizing said audio signals in the frequency domain using said NMRs to determine quantizing levels.

13. The method of claim 12 wherein said determining a representation of the envelope comprises determining e(t), the square of said envelope.

14. The method of claim 12 wherein said determining a representation of said envelope comprises determining \tilde{X}(f), where X(f) is the Fourier transform of x(t), and \tilde{X}(f) is the Fourier transform of the analytic signal corresponding to x(t), \tilde{X}(f) being a single sided frequency spectrum defined as
$$\tilde{X} ( f ) = \{ \begin{matrix}0 & f < 0 \\ X ( f ) & f = 0 \\ 2 X ( f ) & f > 0\end{matrix}$$
for f extending over a frequency range associated with a human cochlea.

15. The method of claim 14 further comprising
filtering said \tilde{X}(f) by a cochlear filter, Hₗ(f) for i=1, 2, . . . N to form representations of said single-sided frequency spectrum for N discrete bands of said frequency range, said representations given by
\tilde{X}ᵢ(f)=\tilde{X}(f)Hₗ(f).

16. The method of claim 15 wherein said determining said envelope comprises determining eᵢ(t) for said N discrete bands in accordance with
eₗ(t)=F⁻¹{∫\tilde{X}ᵢ(ε)·\tilde{X}ᵢ*(ε−f)dε}
where eᵢ(t) is the square of said signal envelope corresponding to the ith cochlea filter band having a characteristic frequency fᵢ.

17. The method of claim 17 wherein said quantifying a roughness measure for said envelope comprises performing a linear prediction of said envelope, eᵢ(t) for each i to determine corresponding banded roughness measures rₛ(i).

18. The method of claim 17 wherein mapping said roughness measure to a NMR comprises normalizing said rₛ(i), for each i, with respect to a roughness measure for a pure tone, rₜ(i), for each i, to form a normalized roughness measure for each i.

19. The method of claim 18 wherein said mapping said roughness measure to a NMR further comprises squaring said normalized roughness measure for each i to form a squared roughness measure for each i.

20. The method of claim 19 wherein each said squared roughness measure is raised to the 4^{th} power to reflect cochlea compression.

21. The method of claim 19 wherein said mapping said roughness measure for each cochlear band i to a NMR comprises determining
$${NMR}_{i} = c \cdot {[ \frac{{r}_{s} ( i )}{{r}_{t} ( i )} ]}^{8} ,$$
where rₜ(i) is the roughness measure for a pure tone for each i, and c is a constant.

22. The method of claim 21 wherein said constant, c, is determined by performing a linear prediction of the envelope, eᵢ(t) for each i for a white noise input signal, thereby determining corresponding banded roughness measures rₙ(i)
substituting said rₙ(i) values for rₛ(i) in
$${NMR}_{i} = c \cdot {[ \frac{{r}_{s} ( i )}{{r}_{t} ( i )} ]}^{8} ,$$
substituting known theoretical values for NMRᵢ for white noise in the immediately preceding equation, thereby determining a value, cᵢ, for each i, and
averaging said values of cᵢ for all i to determine said value for c.
